(19) United States
(12) Patent Application Publication
(10) Pub. No.: US 2015/0246698 A1
(43) Pub. Date: Sep. 3, 2015

(54) CRANE, CRAWLER CHASSIS STRUCTURE, AND METHODS OF ASSEMBLING AND DISASSEMBLING CRAWLER CHASSIS

(71) Applicant: SANY AMERICA INC., Peachtree City, GA (US)

(72) Inventor: WEI-CHAN QIN, HU ZHOU (CN)

(21) Appl. No.: 14/504,286

(22) Filed: Oct. 1, 2014

(30) Foreign Application Priority Data
Mar. 3, 2014 (CN) 201410074845.5

(51) Int. Cl. B62D 55/084; B62D 55/32; B66C 7/10

(52) U.S. Cl. CPC B62D 55/084; B66C 7/10; B62D 55/32

(57) ABSTRACT

In certain aspects, the invention relates to a crane, a crawler chassis structure, and methods of assembling and disassembling the crawler chassis structure. The crawler chassis structure includes a chassis, a pair of crawler frames, two pairs of retractable girders, and connecting members. The pair of crawler frames is connected to the chassis through detachable connection to two pairs of retractable girders. Each connecting member has one end detachably connected to one of the pair of crawler frames and the other end connected to the chassis, or one end detachably connected to the chassis and the other end connected to one of the pair of crawler frames. According to the invented crawler chassis structure, the crawler frames can be assembled or disassembled quickly.

### CROSS-REFERENCE TO RELATED APPLICATION

This application claims the priority to Chinese Patent Application No. 201410074845.5, filed Mar. 3, 2014 in the State Intellectual Property Office of China, which is hereby incorporated herein in its entirety by reference.

### FIELD OF THE INVENTION

The invention relates generally to the field of construction machinery, and more particularly to a crane, a crawler chassis structure, and methods of assembling and disassembling the crawler chassis structure.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the present invention.

A retractable crawler chassis of a crane is designed to meet different working conditions. During operation, the two crawler tracks are extended to a maximum distance. The two crawler tracks may be retracted if the crane is moved in a narrow space. When the crane is to be transported, in order to meet weight requirement according to the relevant laws and regulations, the crawler tracks must be disassembled and transported separately. Therefore, assembly and disassembly are difficult issues. Currently, for a crawler chassis structure, the crawler tracks are generally assembled by using a bridge crane or a hoisting machine with the help of forklift push or manual push, and assembly and disassembly work become cumbersome and low in efficiency. In addition, if the crawler tracks are pulled sideways by using the bridge crane or the hoisting machine, such an operation is in violation of the regulations, and is a potential safety hazard.

Therefore, a heretofore unaddressed need exists in the art to address the aforementioned deficiencies and inadequacies.

### SUMMARY OF THE INVENTION

In view of foregoing, the invention invents a crawler chassis structure, to enable quick and efficient assembly and disassembly of crawler frames from the crawler chassis structure.

In one aspect, the present invention relates to a crawler chassis structure. In certain embodiments, the crawler chassis structure includes: a chassis and a pair of crawler frames. The crawler chassis structure also includes two pair of retractable girders, and the pair of crawler frames is connected to the chassis through the two pair of retractable girders. The pair of crawler frames is detachably connected to the two pairs of retractable girders. The crawler chassis structure further includes a plurality of connecting members, where each of the plurality of connecting members has a first end and a second end. In one embodiment, the first end of each of the plurality of connecting members is detachably connected to one of the pair of crawler frames, and the second end of each of the plurality of connecting members is connected to the chassis. In another embodiment, the first end of each of the plurality of connecting members is connected to one of the pair of crawler frames, and the second end of each of the plurality of connecting members is detachably connected to the chassis.

In certain embodiments, each of the two pair of retractable girders includes a body and a cylinder. The body has a hollow box structure. The cylinder has a first end, and an opposite, second end. The first end of each of the cylinders is connected to the corresponding body, and the second end of the cylinder is connected to the chassis. One end of the body is detachably connected to one of the pair of crawler frames. The chassis has two pair of through holes, and each of the body of the two pairs of retractable girders is assembled inside a corresponding through hole.

In certain embodiments, a first slider is disposed inside the through hole; and/or, a second slider is disposed on an outer wall of the body.

In certain embodiments, an inner wall of the through hole and the first slider are connected by a first bolt, and a first spacer is disposed between the inner wall of the through hole and the first slider.

In certain embodiments, the outer wall of the body and the second slider are connected by a second bolt, and a second spacer is disposed between the outer wall of the body and the second slider.

In certain embodiments, the crawler chassis structure further includes a plurality of first set of connecting pins. The first end of the cylinder and the body of one of the two pairs of retractable girders are connected by one of the first set of connecting pins, and the second end of the cylinder and the chassis are connected by another of the first set of cylinder connecting pins.

In certain embodiments, the crawler chassis structure may further include a second set of connecting pins. The body of one of the two pairs of retractable girders and one of the pair of crawler frames are detachably connected by one of the second set of connecting pins.

In certain embodiments, the crawler chassis structure may also include a third set of connecting pins. The first end of one of the connecting members and one of the pair of crawler frames are detachably connected by one of the third set of connecting pins, and the second end of the one of the connecting members and the chassis are connected by another of the third set of connecting pins.

In another aspect, the present invention relates to a crawler crane have the forgoing crawler chassis structure.

In yet another aspect, the present invention relates to a method of assembling a pair of crawler frames onto a crawler chassis structure. In certain embodiments, the method includes hoisting a pair of crawler frames, one at a time, installing a plurality of connecting members to connect the pair of crawler frames and a chassis, extending two pairs of retractable girders to an extended state, connecting the pair of crawler frames and the two pairs of retractable girders, and disconnecting the plurality of connecting members from the chassis.

In a further aspect, the present invention relates to a method of disassembling a pair of crawler frames from a crawler chassis structure. In certain embodiments, the method includes hoisting a pair of crawler frames, one at a time, installing a plurality of connecting members to connect the pair of crawler frames and a chassis, disconnecting two pairs of retractable girders from the pair of crawler frames, retracting the two pairs of retractable girders to a refracted state, and disconnecting the plurality of connecting members from the chassis.

According to the invention, in the crawler chassis structure of a crawler crane, the pair of crawler frames is connected to the chassis by using the two pairs of retractable girders. When the crawler frames need to be disassembled, a process of disassembling the crawler frames may be implemented by extending the two pairs of retractable girders to an extended state, hoisting the pair of crawler frames, one at a time, using a lifting hook of the crawler crane or another hoisting apparatus, then disconnecting the pair of crawler frames from the two pairs of retractable girders, and refracting the two pairs of retractable girders. During the entire disassembly process, quick disassembly of the pair of crawler frames may be implemented by basically keeping the pair of crawler frames still, and separating the pair of crawler frames from the two pairs of retractable girders through refractions of the two pairs of retractable girders. In addition, the pair of crawler frames remain substantially still, and the pair of crawler frames may be lifted by using the hoisting hook of the crawler crane itself without needing additional auxiliary tools. The disassembly process is simple. Similarly, in a process of assembling the pair of crawler frames onto the crawler chassis structure, the pair of crawler frames is lifted to an assembly position, the two pairs of retractable girders are extended to an extended state, and the pair of crawler frames and the two pairs of retractable girders are connected. The assembly process is simple and quick, and no additional auxiliary tools are needed. The operation is simple as well. At the same time, a plurality of connecting members may be used to connect the pair of crawler frames and the chassis such that the relative position of the crawler frame is fixed to avoid any crawler frame movement caused by detaching the corresponding retractable girder due to a small gap between the crawler frames and the corresponding retractable girder. Similarly, the same principle can be applied to an assembling process. A plurality of connecting members may be used to connect one of the pair of crawler frames and the chassis such that the relative position of the crawler frame is fixed, therefore, the crawler frames is in a stable position without swaying, and the crawler frame 1 is assembled onto the corresponding retractable girder 2 easily.

These and other aspects of the invention will become apparent from the following descriptions of the preferred embodiment taken in conjunction with the following drawings, although variations and modifications therein may be effected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a schematic structural diagram of a crawler chassis structure of a crawler crane according to one embodiment of the present invention.

FIG. 2 is a connection structure of a retractable girder, a chassis, and a crawler frame in the crawler chassis structure shown in FIG. 1.

FIG. 3A is a detailed diagram of a first slider disposed inside a through hole of the chassis in the crawler chassis structure shown in FIG. 1.

FIG. 3B is a detailed diagram of a second slider disposed on the retractable girder in the crawler chassis structure shown in FIG. 1.

FIG. 3C is an exploded assembly diagram of a second slider disposed on the retractable girder in the crawler chassis structure shown in FIG. 1.

FIG. 4 is a schematic structural diagram of a part of the crawler chassis structure shown in FIG. 1 being lifted.

FIG. 5 is a partial perspective view of a crawler chassis structure of a crawler crane according to one embodiment of the present invention.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top,” and “front” or “back” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximates, meaning that the term “around”, “about” or “approximately” can be inferred if not expressly stated.

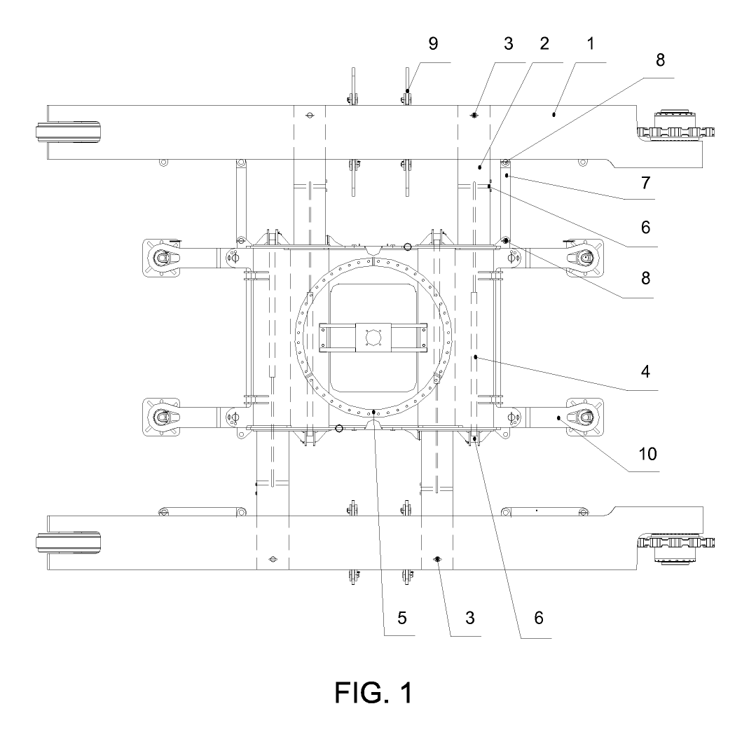

The description will be made as to the embodiments of the invention in conjunction with the accompanying drawings in FIGS. 1-5. In accordance with the purposes of this invention, as embodied and broadly described herein, this invention, in certain aspects, relates to a crane, a crawler chassis structure, and methods of assembling and disassembling the crawler chassis structure.

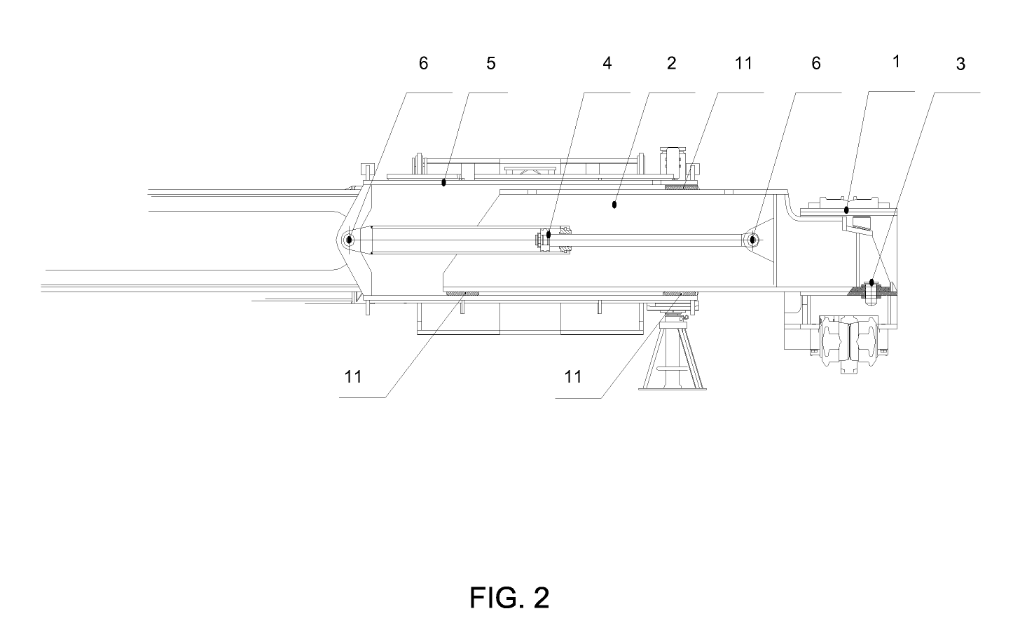

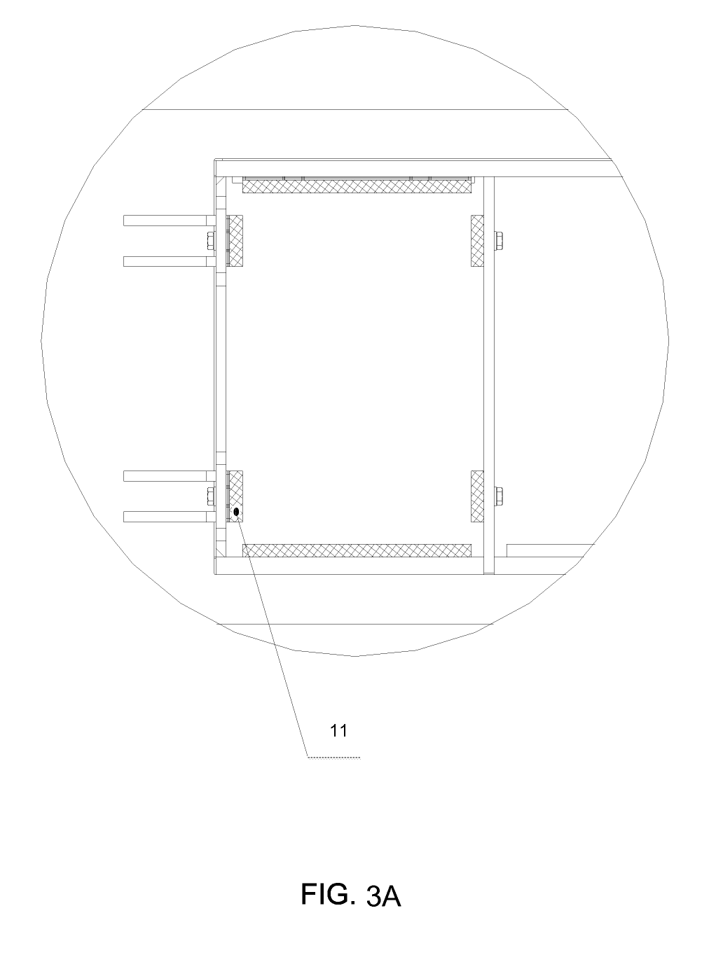

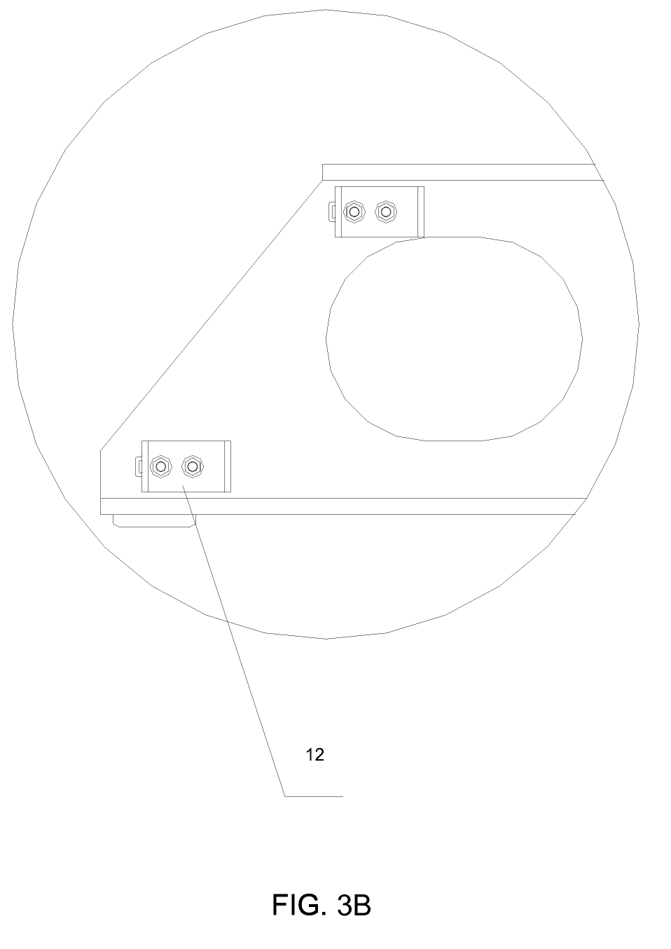

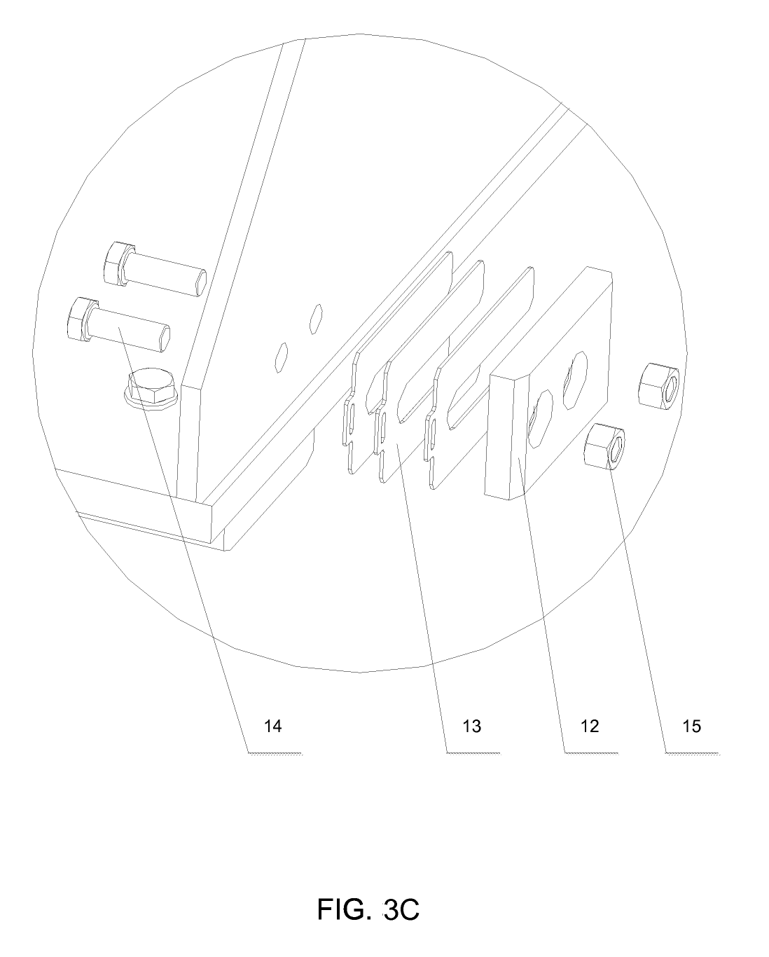

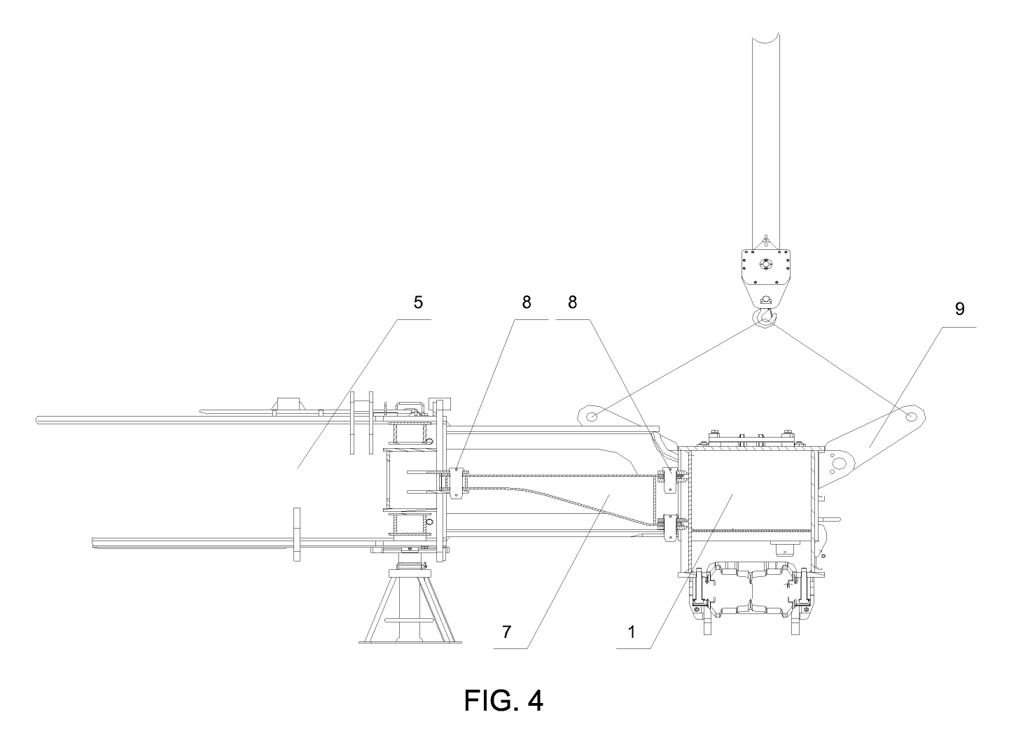

FIG. 1 is a schematic structural diagram of a crawler chassis structure according to one embodiment of the present invention. FIG. 2 is a connection structure of a retractable girder, a chassis, and a crawler frame in the crawler chassis structure shown in FIG. 1. FIG. 3A is a detailed diagram of a first slider being disposed inside a through hole of the chassis in the crawler chassis structure shown in FIG. 1. FIG. 3B is a detailed diagram of a second slider being disposed on the retractable girder in the crawler chassis structure shown in FIG. 1. FIG. 3C is an exploded assembly diagram of a second slider that is disposed on the retractable girder in the crawler chassis structure shown in FIG. 1. FIG. 4 is a schematic structural diagram of a part of structures being in a hoisting state in the crawler chassis structure shown in FIG. 1.

In the exemplary embodiment, as shown in FIG. 1, the crawler chassis structure includes a pair of crawler frames 1, two pairs of retractable girders 2, and a chassis 5. The pair of crawler frames 1 is connected to the chassis 5 through the two pairs of retractable girders 2. The pair of crawler frames 1 is detachably connected to the two pairs of retractable girders 2. The crawler chassis structure further includes several connecting members 7. In one embodiment, each connecting member 7 has a first end detachably connected to one of the pair of crawler frames 1 and an opposite, second end connected to the chassis 5. In another embodiment, the first end of the connecting member 7 is detachably connected to the chassis 5, while the second end is connected to one of the pair of crawler frames 1.

The pair of crawler frames 1 is connected to the chassis 5 through the two pairs of retractable girders 2. When one of the pair of crawler frames 1 needs to be disassembled, a process of disassembling the crawler frame 1 may be implemented by extending the corresponding one of two pairs of retractable girders 2 to an extended state, lifting the crawler frame 1 by using a lifting hook of a hoisting machine (for example, the crane) or another hoisting apparatus, then disconnecting the crawler frame 1 from the corresponding retractable girder 2, and retracting the retractable girder 2. During the disassembling process, a quick disassembly of the crawler frame 1 may be implemented by basically keeping the crawler frame 1 still, and separating the crawler frame 1 and the corresponding retractable girder 2 by retracting the retractable girder 2. In addition, since the crawler frame 1 remains substantially still, the crawler frame 1 may be lifted by using the hoisting hook of the hoisting machine itself without other auxiliary tools. Such disassembly process is simple. Similarly, the same principle can be applied to assemble a crawler frame 1. One of the pair of crawler frames 1 may be lifted to an assembly position. One of the two pairs of retractable girders 2 is extended to an extended state, and the crawler frame 1 and the corresponding retractable girder 2 are connected. The assembling process does not require other auxiliary tools, and the assembling process is simple and quick. During the assembling process, one or more of the connecting members 7 may be used to connect the one of the pair of crawler frames 1 and the chassis 5 such that the relative position of the crawler frame 1 is fixed to avoid any crawler frames 1 movement caused by attaching the corresponding retractable girder 2 due to a small gap between the crawler frames 1 and the corresponding retractable girder 2. The connecting members 7 are used to ensure that the relative position of the crawler frame 1 is fixed, the crawler frames 1 is in a stable position without swaying, and the crawler frame 1 is assembled onto the corresponding retractable girder 2 easily.

There may be many different ways to connect one of the pair of crawler frames 1 to the chassis 5 through the two pairs of retractable girders 2. In one embodiment, one of the pair of crawler frames 1 is disposed on one side (left) of the chassis 5, and the other one of the pair of crawler frames 1 is disposed on the opposite side (right) of the chassis 5. As shown in FIG. 1, one end of one of the two pairs of retractable girders 2 is connected to the chassis 5, and the other end of the retractable girder 2 is detachably connected to one of the pair of crawler frames 1 on one side. In this way, each of the pair of crawler frames 1 requires at least a pair of the two pairs of retractable girders 2 to be separately and correspondingly connected to the crawler frame 1. In one embodiment, as shown in FIG. 1, in order to balance both left and right structures of the chassis 5, each of the pair of crawler frame 1 is correspondingly connected to the chassis 5 through a pair of the two pairs of retractable girders 2, one in the front side of the chassis 5, and the other one in the rear side of the chassis 5. The crawler chassis structure uses a total of four retractable girders 2, two in the front side of the chassis 5, and two in the rear side of the chassis 5.

In certain embodiments, each of the two pairs of retractable girders 2 includes a body and a cylinder 4. The body of the retractable girder 2 has a hollow-type box structure. The cylinder 4 has a first end, and an opposite, second end. The first one end of the cylinder 4 is connected to the body, and the second end of the cylinder 4 is connected to the chassis 5. One end of the body is detachably connected to one of the pair of crawler frames 1. The chassis 5 has a through hole for each of the two pairs of retractable girders 2, and the body of each of the two pairs of retractable girders 2 is assembled inside a corresponding through hole. The crawler chassis structure further includes a first set of connecting pins 6. The first end of the cylinder 4 is connected to the body by using one of the first set of connecting pins 6, and the second end of the cylinder 4 is connected to the chassis 5 by using another one of the first set of connecting pins 6. In certain embodiments, the crawler chassis structure further includes a second set of connecting pins 3. One end of the body is detachably connected to one of corresponding crawler frame 1 by using one of the second set of connecting pins 3. The crawler chassis structure further includes a third set of connecting pins 8. In one embodiment, the first end of each of the connecting members 7 is detachably connected to a corresponding crawler frame 1 by using one of the third set of connecting pins 8, and the second end of the each of the connecting members 7 is connected to the chassis 5 by using another one of the third set of connecting pins 8. In another embodiment, the first end of each of the connecting members 7 is connected to a corresponding crawler frame 1 by using one of the third set of connecting pins 8, and the second end of each of the connecting members 7 is detachably connected to the chassis 5.

Each of the two pairs of retractable girders 2 can relatively move inside a corresponding through hole of the chassis 5. In order to reduce frictional resistance caused by the relative movement and prevent machining of two relative moving surfaces, as shown in FIG. 3A to FIG. 3C, in one embodiment, a first slider 11 is disposed inside each one of the through holes of the chassis 5, and a second slider 12 is disposed on an outer wall of the each of the bodies of the two pair of retractable girders 2. A first slider 11 may be connected to an inner wall of each of the through holes by using one of a first set of bolts. A second slider 12 may be connected to the outer wall of the each of the bodies of the two pair of retractable girders 2 by using one of a second set of bolts 14.

In certain embodiments, a first spacer is placed between the inner wall of one of the through holes and the corresponding first slider 11 to reduce the gap between the retractable girder 2 and the corresponding through hole of the chassis 5. Similarly, a second spacer 13 (may be insertable) may also be placed between the outer wall of each of the bodies of the two pairs of retractable girders 2 and a corresponding second slider 12. When one of the second set of bolts 14 is not removed, but only loosened, a second spacer 13 can be conveniently inserted, making the gap adjustment convenient.

In one embodiment, as shown in FIG. 3A, in one of the through holes (for example, a square hole) of the chassis 5, six of the first sliders 11 are used, separately: one on inside of a top surface, one on inside of a bottom surface, two on inside of a left surface, and two on inside of a right surface. In one embodiment, as shown in FIG. 3B, on each of the retractable girders 2, several second sliders 12 may be used, for example, one on the outer wall of a bottom surface, two on the outer wall of a left surface, and two on the outer wall of a right surface. FIG. 3C is an exploded assembly diagram of a second slider. Each of the second sliders 12 may be installed by using one or more of the second set of bolts 14 and the same number of corresponding hexagonal nuts 15. The hexagonal nuts 15 cannot protrude beyond a corresponding movement contact surface. Each of the hexagonal nuts 15 may be embedded into a correspondingly fit hexagonal notch on one of the second sliders 12 to ensure that the nut 15 is not rotatable during its installation. The first sliders 11 and the second sliders 12 may be made of a nylon material, and may be conveniently replaced after they are worn.

Referring now to FIG. 4, in one embodiment, when the pair of crawler frames 1 on a crawler crane needs to be disassembled for separate transportation, several chassis retractable cylinders 10 are extended to the ground and lift the pair of crawler frames 1 off the ground. If the first end of the connecting member 7 is assembled on a corresponding crawler frame 1 as initial configuration, the connecting member 7 is rotated to make the connecting frame 7 rotate around a corresponding one of the third set of connecting pins 8 on the crawler frame 1 to a position perpendicular to the crawler frame 1, and the second end of the connecting member 7 is connected to the chassis 5 and is fixed by using another one of the third set of connecting pins 8. Two of the second set of connecting pins 3 are removed by attaching a crawler frame lifting lug 9 to the crawler frame 1 and holding the crawler frame 1 using the lifting hook of the crawler crane. The two cylinders 4 of the two retractable girders 2 are then retracted, and the two retractable girders 2 are separated from the crawler frame 1. The two of the third set of connecting pins 8 between the two connecting members 7 and the chassis 5 are then removed, and the two retractable girders 2 are disconnected from the crawler frame 1, and the lifting hook may remove the crawler frame 1 (the two connecting members 7 may be rotated and fixed on the crawler frame 1 to accommodate the two connecting members 7), so as to complete the entire disassembly process. Both crawler frames 1 are disassembled in similar manner. Similarly, when the crawler crane and its pair of crawler frames 1 arrive at another work site, the pair of crawler frames 1 may be assembled onto the crawler crane in a similar procedure.

It may be understood that, the shape of the connecting members 7 between the chassis 5 and the crawler frames 1 may be manufactured according to actual applications, and the present invention is not limited to the shapes of the connecting members 7 as illustrated in FIG. 1 to FIG. 4. The number of the foregoing sets of connecting pins 3, 6, and 8 may be determined according to actual applications. The sets of the first sliders 11, and the second sliders 12 may use different materials. The present invention is not limited to just nylon sliders.

In certain embodiment, the pair of crawler frames 1 is connected to the chassis 5 through the two pairs of retractable girders 2, one pair of retractable girders 2 for each crawler frame 1. When the pair of crawler frames 1 needs to be disassembled, only the equipment already on the crawler crane (for example, chassis retractable cylinders and the lifting hook of the crawler crane) are used to implement quick disassembly of the pair of crawler frames 1. No additional auxiliary tools are needed, so that the disassembly is simple and quick. A process of assembling the pair of crawler frames 1 is also simple and quick because no additional auxiliary tools are needed either. Preferably, several connecting members 7 are used as auxiliary apparatus between the chassis 5 and the pair of crawler frames 1 to assist in assembling and disassembling the pair of crawler frames 1 and to implement quick assembly and disassembly of the pair of crawler frames 1. A certain number of nylon sliders (the first sliders 11, and the second slider 12) and certain number of spacers are disposed between the chassis 5 and the pair of retractable girders 1. The spacers are used to adjust assembly gaps, and such operation is simple. In certain embodiments, it is not required to machine the surfaces of the through holes of the chassis 5 and surfaces of the corresponding retractable girders 2 in contact with the surfaces of the through holes of the chassis 5. Only nylon sliders are used to reduce the friction. Therefore, the manufacturing cost is low.

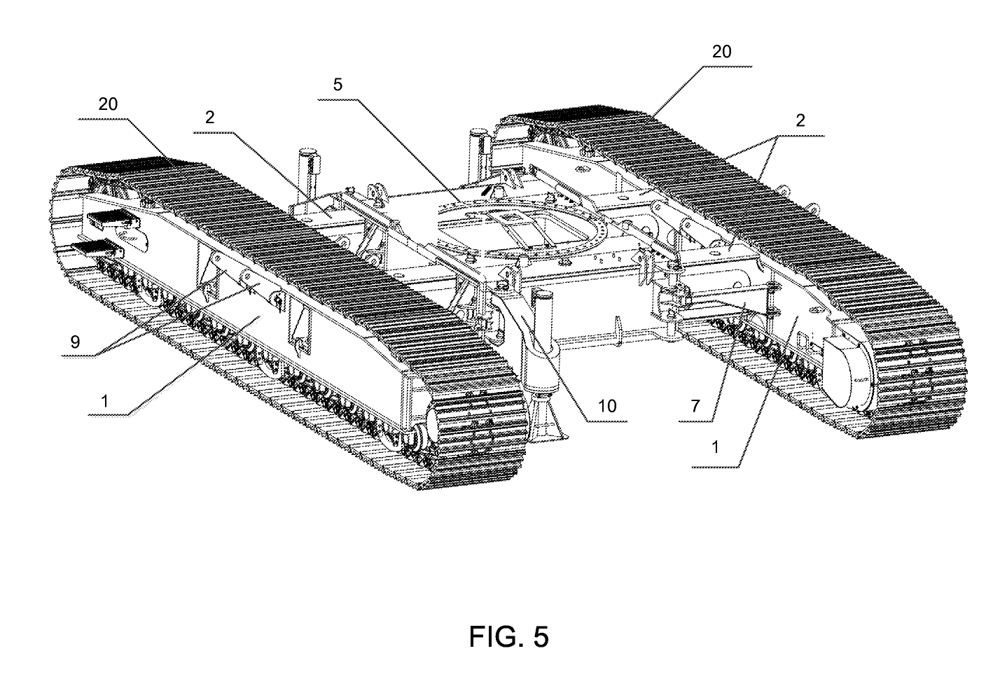

Referring now to FIG. 5, a partial perspective view of crawler chassis structure of a crawler crane is shown according to certain embodiments of the present invention. The crawler chassis structure includes a pair of crawler frames 1, two pairs of retractable girders 2, and a chassis 5. A pair of tracks 20 is used to assist the movement of the crawler crane. One track 20 is installed on each of the pair of crawler frames 1. In certain embodiments, four chassis retractable cylinders 10 are used to stabilize the crawler crane when the pair of crawler frames 1 need to be attached or detached for separate transportation. The chassis retractable cylinders 10 should be lifted off the ground if the crawler crane moves. Several crawler frame lifting lugs 9 are placed on the pair of crawler frames 1. When the pair of crawler frames 1 are attached to or detached from the chassis 5, the crawler frame lifting lugs 9 are used to lift the crawler frame 1. The pair of crawler frames 1 is connected to the chassis 5 through the two pairs of retractable girders 2. The pair of crawler frames 1 is detachably connected to the two pairs of retractable girders 2. The crawler chassis structure further includes several connecting members 7. In one embodiment, each connecting member 7 has a first end detachably connected to one of the pair of crawler frames 1 and an opposite, second end connected to the chassis 5. In another embodiment, the first end of the connecting member 7 is detachably connected to the chassis 5, while the second end is connected to one of the pair of crawler frames 1.

The pair of crawler frames 1 is connected to the chassis 5 through the two pairs of retractable girders 2. When one of the pair of crawler frames 1 needs to be disassembled, a process of disassembling the crawler frame 1 may be implemented by extending the corresponding one of two pairs of retractable girders 2 to an extended state, lifting the crawler frame 1 by using a lifting hook of a hoisting machine (for example, the crane) or another hoisting apparatus, then disconnecting the crawler frame 1 from the corresponding retractable girder 2, and retracting the retractable girder 2. During the disassembling process, a quick disassembly of the crawler frame 1 may be implemented by basically keeping the crawler frame 1 still, and separating the crawler frame 1 and the corresponding retractable girder 2 by retracting the retractable girder 2. In addition, since the crawler frame 1 remains substantially still, the crawler frame 1 may be lifted through crawler frame lifting lugs 9 by using the hoisting hook of the crawler crane itself without other auxiliary tools. Such disassembly process is simple. Similarly, a reverse process can be used to assemble or attache a crawler frame 1. One of the pair of crawler frames 1 may be lifted to an assembly position. One of the two pairs of retractable girders 2 is extended to an extended state, and the crawler frame 1 and the corresponding retractable girder 2 are connected. The assembling process does not require other auxiliary tools, and the assembling process is simple and quick. During the assembling process, one or more of the connecting members 7 may be used to connect the one of the pair of crawler frames 1 and the chassis 5 such that the relative position of the crawler frame 1 is fixed to avoid any crawler frames 1 movement caused by attaching the corresponding retractable girder 2 due to a small gap between the crawler frames 1 and the corresponding retractable girder 2. The connecting members 7 are used to ensure that the relative position of the crawler frame 1 is fixed, the crawler frames 1 is in a stable position without swaying, and the crawler frame 1 is assembled onto the corresponding retractable girder 2 easily.

The present invention further relates to a crawler crane having a crawler chassis structure. The crawler crane has a corresponding technical effect of the forgoing crawler chassis structure, and will not be repeated here.

In another aspect, the present invention relates to a method of assembling a pair of crawler frames onto a crawler chassis structure. For the method of assembling the crawler chassis structure, reference may be made to explanations and descriptions of the foregoing embodiments of the crawler chassis structure. In certain embodiments, the method of assembling the pair of crawler frames onto the crawler chassis structure includes: lifting a pair of crawler frames 1, one at a time, installing a plurality of connecting members 7 to connect the pair of crawler frames 1 and a chassis 5, extending two pairs of retractable girders 2 to an extended state, connecting the pair of crawler frames 1 and the two pairs of retractable girders 2, and disconnecting the plurality of connecting members 7 from the chassis 5.

In yet another aspect, the present invention relates to a method of disassembling a pair of crawler frames from a crawler chassis structure. For the method of disassembling the crawler chassis structure, reference may be made to explanations and descriptions of the foregoing embodiments of the crawler chassis structure. In certain embodiments, the method of disassembling the pair of crawler frames from the crawler chassis structure includes: lifting a pair of crawler frames 1, one at a time, installing a plurality of connecting members 7 to connect the pair of crawler frames 1 and a chassis 5, disconnecting two pairs of retractable girders 2 from the pair of crawler frames 1, retracting the two pairs of retractable girders 2 to a retracted state, and disconnecting the plurality of connecting members 7 from the chassis 5.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. A crawler chassis structure, comprising:
a chassis;
a pair of crawler frames;
two pairs of retractable girders, wherein the pair of crawler frames is connected to the chassis through the two pairs of retractable girders, and wherein the pair of crawler frames is detachably connected to the two pairs of retractable girders; and
a plurality of connecting members, each of the plurality of connecting members having a first end detachably connected to one of the pair of crawler frames and an opposite, second end connected to the chassis, or the first end having detachably connected to the chassis and the second end connected to one of the pair of crawler frames.

2. The crawler chassis structure according to claim 1, wherein each of the two pairs of retractable girders comprises:
a body having a hollow box structure, wherein the body is assembled in a through hole provided on the chassis, and the body is detachably connected to one of the pair of crawler frames; and
a cylinder having a first end connected to the body and an opposite, second end connected to the chassis.

3. The crawler chassis structure according to claim 2, wherein a first slider is disposed inside the through hole; and/or, a second slider is disposed on an outer wall of the body of the girder.

4. The crawler chassis structure according to claim 3, wherein an inner wall of the through hole and the first slider are connected by a first bolt, wherein a first spacer is disposed between the inner wall of the through hole and the first slider.

5. The crawler chassis structure according to claim 3, wherein the outer wall of the body and the second slider are connected by a second bolt, wherein a second spacer is disposed between the outer wall of the body and the second slider.

6. The crawler chassis structure according to claim 3, further comprising:
a first set of connecting pins, wherein the first end of the cylinder and the body of one of the two pairs of retractable girders are connected by one of the first set of connecting pins, and the second end of the cylinder and the chassis are connected by another of the first set of cylinder connecting pins; and/or
a second set of connecting pins, wherein the body of one of the two pairs of retractable girders and one of the pair of crawler frames are detachably connected by one of the second set of connecting pins.

7. The crawler chassis structure according to claim 6, further comprising a third set of connecting pins, wherein the first end of one of the connecting members and one of the pair of crawler frames are detachably connected by one of the third set of connecting pins, and the second end of the one of the connecting members and the chassis are connected by another of the third set of connecting pins.

8. A crane, comprising the crawler chassis structure according to claim 1.

9. A method of assembling the crawler chassis structure according to claim 1, comprising:
hoisting at least one of the pair of crawler frames;
installing the plurality of connecting members to connect the pair of crawler frames and the chassis;
extending the two pairs of retractable girders to an extended state;
connecting the pair of crawler frames and the two pairs of retractable girders; and
disconnecting the plurality of connecting members from the chassis.

10. A method of disassembling a crawler chassis structure according to claim 1, comprising:
hoisting one of the pair of crawler frames;
installing the plurality of connecting members to connect the pair of crawler frames and the chassis;
disconnecting the two pairs of retractable girders from the pair of crawler frames;
retracting the two pairs of retractable girders to a retracted state; and
disconnecting the plurality of connecting members from the chassis.
